(19) United States
(12) Patent Application Publication
(10) Pub. No.: US 2025/0317386 A1
(43) Pub. Date: Oct. 9, 2025

(54) GREENEST PATH ROUTING IN A SWITCHED COMMUNICATIONS FABRIC

(71) Applicant: INTERNATIONAL BUSINESS MACHINES CORPORATION, ARMONK, NY (US)

(72) Inventors: PASQUALE A. CATALANO, WALLKILL, NY (US); JOHN S. WERNER, FISHKILL, NY (US); ARKADIY O. TSFASMAN, WAPPINGERS FALLS, NY (US); ANDREW GERALD CRIMMINS, MONTROSE, NY (US)

(21) Appl. No.: 18/626,535

(22) Filed: Apr. 4, 2024

(51) Int. Cl. H04L 45/302; H04L 12/14; H04L 45/745; H04L 49/356

(52) U.S. Cl. CPC H04L 45/308; H04L 12/1432; H04L 45/745; H04L 49/357

(57) ABSTRACT

Greenest path routing in a switched communications fabric can include identifying, from a header provided with a packet received at a first device, a sustainability policy associated with the packet; selecting a path to a next device along a route to a destination endpoint based on a one or more sustainability metrics associated with the path and the sustainability policy; and transmitting the packet using the path to the next device.

### BACKGROUND

The present disclosure relates to methods, apparatus, and products for greenest path routing in a switched communications fabric. Enterprises are increasingly scrutinizing their carbon footprint and making efforts to improve their environmental impact. As every aspect of a digital presence requires some amount of energy consumption, it is difficult to monitor all of these aspects to ensure that the system as a whole is meeting sustainability goals and targets.

### SUMMARY

According to embodiments of the present disclosure, various methods, apparatus and products for greenest path routing in a switched communications fabric are described herein. In some aspects, greenest path routing in a switched communications fabric includes identifying, at a first device, a sustainability policy associated with a packet from a header provided with the packet received. A path to a next device along a route to a destination endpoint is selected based on one or more sustainability metrics associated with the path and the sustainability policy. The packet is then transmitted using the path to the next device. In this way, the sustainability metrics are used to identify a particular path that is relatively ‘greener’ that other paths in accordance with a sustainability policy, which reduces the overall energy demand of routing the packet and improves the performance and energy efficiency of a communications fabric. A customer of an infrastructure-as-a-service can then use the sustainability policy included in a packet generated by the customer to ensure that packets it sends to the infrastructure will be routed in accordance with its sustainability goals and targets.

### BRIEF DESCRIPTION OF THE DRAWINGS

FIG. 1 sets forth an example of a network environment for greenest path routing in a switched communications fabric in accordance with aspects of the present disclosure.

FIG. 2 sets forth an example computing environment according to aspects of the present disclosure.

FIG. 3 sets forth another example of a network environment for greenest path routing in a switched communications fabric in accordance with at least one embodiment of the present disclosure.

FIG. 4A sets forth an example frame structure in accordance with at least one embodiment of the present disclosure.

FIG. 4B sets forth an example sustainability header structure in accordance with at least one embodiment of the present disclosure.

FIG. 5 sets forth a flow chart of an example method in accordance with at least one embodiment of the present disclosure.

FIG. 6 sets forth a flow chart of another example method in accordance with at least one embodiment of the present disclosure.

FIG. 7 sets forth a flow chart of another example method in accordance with at least one embodiment of the present disclosure.

FIG. 8 sets forth a flow chart of another example method in accordance with at least one embodiment of the present disclosure.

### DETAILED DESCRIPTION

Presently, customers of an infrastructure-as-a-service offering, such as a storage area network (SAN), do not have the option to set sustainability targets for that infrastructure. Typically, ‘shortest path first’ is the default routing policy, which could lead to higher power consumption. There may be alternate paths that consume less power, but the customer is not provided with the option to select such paths.

In accordance with aspects of the present disclosure, a packet is provided with a sustainability header that enables the setting of a sustainability policy used for routing the packet within the infrastructure. The customer can thus select a ‘green’ policy for packet routing. A path between endpoints is selected based on sustainability metrics associated with the path. For example, the path is selected based on an energy demand of the infrastructure devices and the links between them. As the packet traverses the path, the header can be updated with the energy demand of each hop such that the energy demand of the ‘green’ path can be compared to the energy demand based on a standard routing policy. This improves the infrastructure by allowing the customer and the operator of the infrastructure to determine whether sustainability targets are being met. Further, the information is fed back into the system to improve the energy efficiency and performance of devices within the infrastructure. For example, where ‘green’ paths that meet service level requirements can be identified, the system may use that information to set routing tables to reduce the overall energy demand of the infrastructure, even if the customer does not set the sustainability policy.

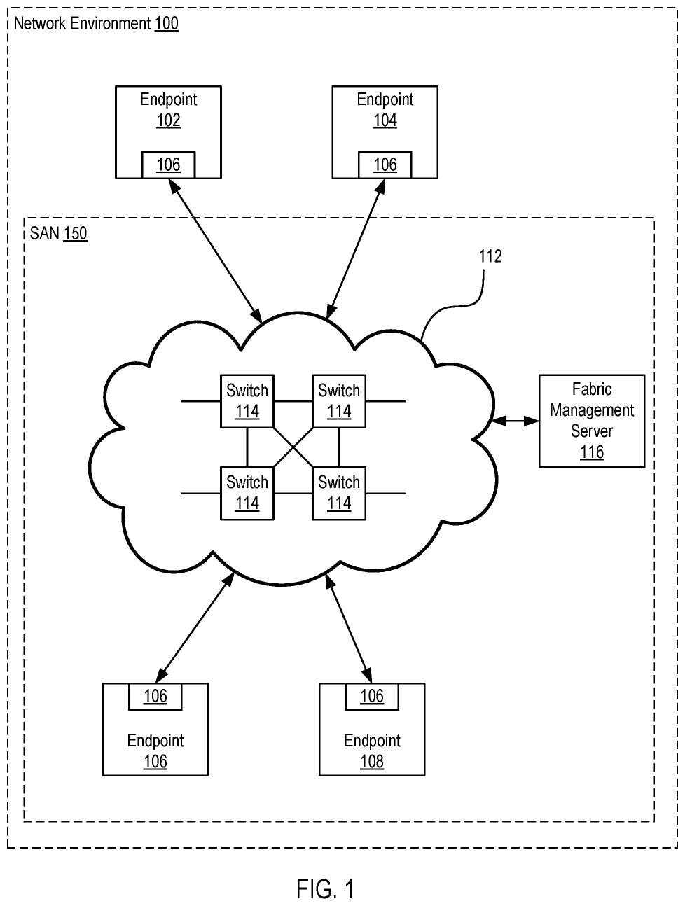

For further explanation, FIG. 1 sets forth an example network environment 100 for greenest path routing in a switched communications fabric in accordance with the present disclosure. Network environment 100 includes a number of endpoints 102, 104, 106, 108. Endpoints 102, 104, 106, 108 may be embodied as, for example, a server, a workstation, a mainframe, a personal computer, a notebook, a storage device, and the like. Each endpoint 102, 104, 106, 108 includes one or more host bus adapters 116, implemented in software or hardware, that connect the endpoints 102, 104, 106, 108 to a switched fabric 112. The switched fabric 112 includes a number or switches 114 configured to receive packets of data from initiated by a source endpoint and route the packets to a next switch or device (also referred to herein as a ‘next hop’) in route to a particular destination endpoint.

The switched fabric 112 is configured to utilize a variety of different protocols and fabric topologies to facilitate data communications between components of the network environment 100. For example, the switched fabric 112 can include fibre channel (‘FC’) technologies such as FC fabrics and FC protocols that can transport SCSI commands over FC networks. The switched fabric 112 can also include FC over ethernet (‘FCoE’) technologies through which FC frames are encapsulated and transmitted over Ethernet networks. The switched fabric 112 can also include InfiniBand (‘IB’) technologies in which a switched fabric topology is utilized to facilitate transmissions between channel adapters. It will be appreciated that other switched fabric topologies can be utilized in accordance with aspects of the present disclosure.

In a particular example, network environment 100 includes a storage area network (SAN) 150 in which some endpoint 106, 108 are data storage devices such as storage arrays, tape storage, and the like. In such an example, other endpoints 102, 104, acting as host devices, issue storage commands to endpoints 106, 108 through switched fabric 112. The SAN 150 may be implemented with a variety of data communications fabrics, devices, and protocols. For example, the fabrics for SAN 150 may include Fibre Channel, Ethernet, Infiniband, Serial Attached Small Computer System Interface (‘SAS’), or the like. Data communications protocols for use with SAN 150 may include Advanced Technology Attachment (‘ATA’), Fibre Channel Protocol, Small Computer System Interface (‘SCSI’), Internet Small Computer System Interface (‘iSCSI’), HyperSCSI, Non-Volatile Memory Express (‘NVMe’) over Fabrics, or the like.

In a particular example, the switched fabric 112 is a Fibre Channel fabric. A Fibre Channel fabric employs a mesh topology allowing multiple routes for data to travel between endpoints. This redundancy enhances fault tolerance and reliability. In such an example, the switches 114 are configured as Fibre Channel switches that are coupled by Fibre Channel links. A Fibre Channel switch can include at least eight ports. The port of one switch is connected to the port of another switch via link comprising an optical fiber. Fibre Channel supports various link speeds measured in gigabits per second (Gbps), including 1 Gbps, 2 Gbps, 4 Gbps, 8 Gbps, 16 Gbps, and 32 Gbps. The host bus adapters (e.g., host bus adapters 116) of the endpoints of the Fibre Channel fabric may be a Fibre Channel adapter that enables the endpoints to communicate. A logical connection between two switches and between an endpoint and a switch is also referred to as a ‘path.’ When routing a packet (also referred to as a ‘frame’), each switch 114 forwards data packets from one network device to the next, progressively moving them closer to their endpoint. In routing, a ‘next hop’ refers to the immediate neighbor or the next switch to which a packet is forwarded along its route. Each switch 114 in the route to the endpoint makes an independent forwarding decision based on its routing table. In making the decision, the switches chooses a path for the next hop. As the path between two switches can include multiple links corresponding to the multiple ports, in some examples, these links can have different speeds. For example, there may be one or more 32 Gbps links and one or more 16 Gbps links, or one or more 8 Gbps links, between devices in the fabric.

Routing decisions can be made using a variety of mechanisms and based on a variety of factors in the fabric. Such factors can include latency, bandwidth, congestion, minimizing the number of hops, and so on. In accordance with embodiments of the present disclosure, another factor that is used to make routing decisions is based on sustainability and the promotion of ‘green’ technology.

As used herein, ‘sustainability’ refers to environmental and ecological sustainability and the capacity to promote so-called ‘green’ initiatives such as energy, resource, and ecological conservation and mitigation against water pollution, air pollution, fossil-fuel depletion, ozone depletion, climate change, and so on. Thus, the feature of reducing environmental and ecological impact and promoting sustainability is herein synonymous with the term ‘green.’ To that end, as used herein a ‘sustainability metric’ is a representative measure of the environmental and ecological impact embodied in the utilization of a particular technological device or feature. In other words, a sustainability metric is a measure of how ‘green’ a technological feature is. In the context of packet routing between two endpoints, a sustainability metric can indicate that one path is greener than another path. For example, in selecting a path to a next device in route to the endpoint, a device will be associated with a more favorable sustainability metric if the device has a lower energy demand, for example, by employing power conservation mechanisms or otherwise being more energy efficient, if the device is located in a data center that is managed to meet sustainability goals, if the device operates from a power grid or source that utilizes renewable energy, and so on. Further, the speed of a communication link to the device can influence the sustainability rating of the path, where faster links are associated with greater energy demand (e.g., the energy demand of lasers in a fiber optic link).

In accordance with aspects of the present disclosure, a fabric switch or other fabric device includes a sustainability module that makes routing decisions based on sustainability metrics. In some examples, the sustainability module identifies a sustainability policy associated with a packet from a header of the packet. The sustainability module selects a path to a next device along a route to a destination endpoint, or a next hop, based on a sustainability metric associated with the path and the sustainability policy. The current device then forwards the packet using the path to the next device in adherence to the sustainability policy. In some examples, prior to transmission, the device updates the header with a sustainability value based on the value of that device's sustainability metric.

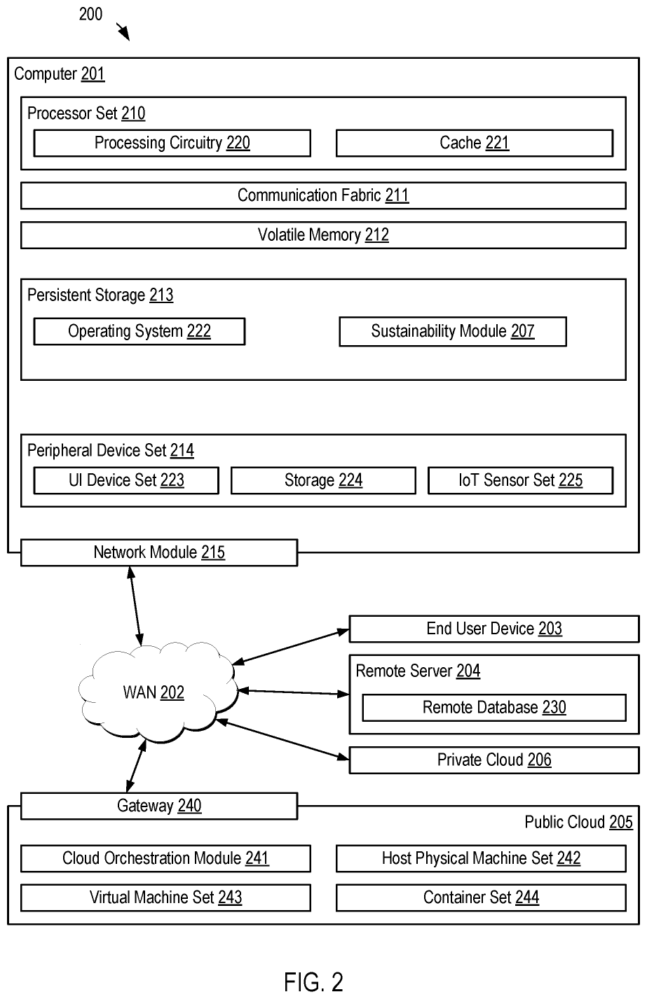

FIG. 2 sets forth an example computing environment according to aspects of the present disclosure. Computing environment 200 contains an example of an environment for the execution of at least some of the computer code involved in performing the various methods described herein, such as sustainability module 207. In addition to block 207, computing environment 200 includes, for example, computer 201, wide area network (WAN) 202, end user device (EUD) 203, remote server 204, public cloud 205, and private cloud 206. In this embodiment, computer 201 includes processor set 210 (including processing circuitry 220 and cache 221), communication fabric 211, volatile memory 212, persistent storage 213 (including operating system 222 and block 207, as identified above), peripheral device set 214 (including user interface (UI) device set 223, storage 224, and Internet of Things (IoT) sensor set 225), and network module 215. Remote server 204 includes remote database 230. Public cloud 205 includes gateway 240, cloud orchestration module 241, host physical machine set 242, virtual machine set 243, and container set 244.

Computer 201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible. Computer 201 may be located in a cloud, even though it is not shown in a cloud in FIG. 2. On the other hand, computer 201 is not required to be in a cloud except to any extent as may be affirmatively indicated.

Processor set 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 221 and the other storage media discussed below. The program instructions, and associated data, are accessed by processor set 210 to control and direct performance of the computer-implemented methods. In computing environment 200, at least some of the instructions for performing the computer-implemented methods may be stored in block 207 in persistent storage 213.

Communication fabric 211 is the signal conduction path that allows the various components of computer 201 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, volatile memory 212 is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

Persistent storage 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid state storage devices. Operating system 222 may take several forms, such as various known proprietary operating systems or open source Portable Operating System Interface-type operating systems that employ a kernel. The code included in block 207 typically includes at least some of the computer code involved in performing the computer-implemented methods described herein.

Peripheral device set 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database), this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

Network module 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the computer-implemented methods can typically be downloaded to computer 201 from an external computer or external storage device through a network adapter card or network interface included in network module 215.

WAN 202 is any wide area network (for example, the internet) capable of communicating computer data over non-local distances by any technology for communicating computer data, now known or to be developed in the future. In some embodiments, the WAN 202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 203 is any computer system that is used and controlled by an end user (for example, a customer of an enterprise that operates computer 201), and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

Remote server 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

Public cloud 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

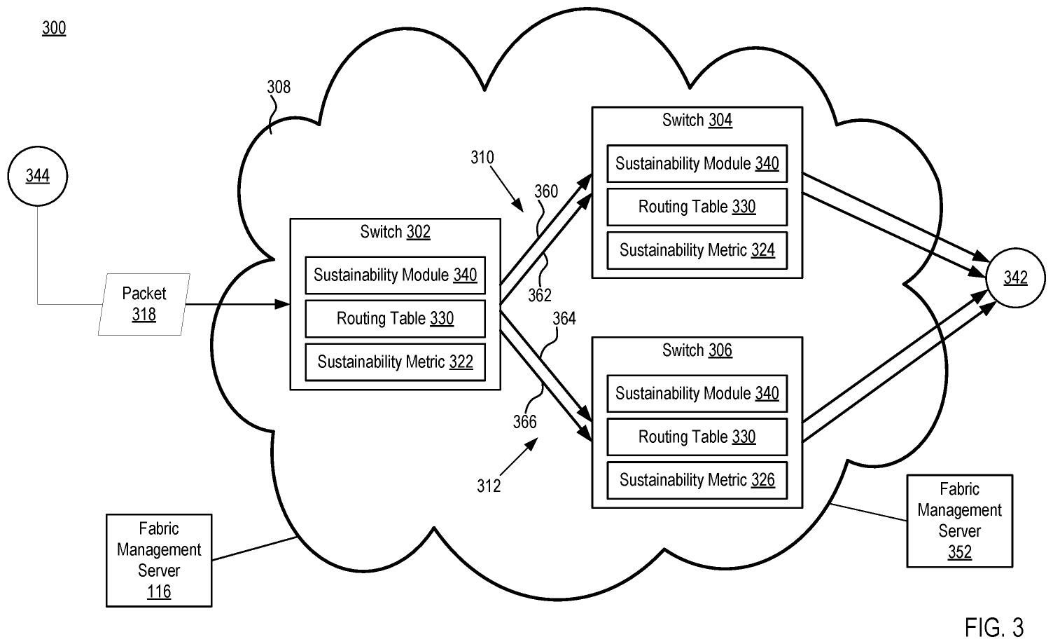

For further explanation, FIG. 3 sets forth a block diagram of an example network environment 300 for greenest path routing in a switched communications fabric in accordance with at least one embodiment of the present disclosure. The network environment 300 is similar to the network environment 100 of FIG. 1, except that network environment 300 is shown with an example switch topology. The example network environment 300 includes a fabric 308 coupling an initiator endpoint 344 (e.g., a host device) to a destination endpoint 342 (e.g., a storage device). The fabric 308 includes switches 302, 304, 306. A first path 310 is a logical connection between switch 302 and switch 304. The first path 310 represents one or more physical links 360, 362, each link connecting a port of switch 302 to a port of switch 304. A second path 312 is a logical connection between switch 302 and switch 306. The second path 312 represents one or more physical links 364, 366, each link connecting a port of switch 302 to a port of switch 306. A packet 318 arriving at switch 302 will be routed to the destination endpoint 342 through either switch 304 or switch 306, depending on the routing decision made by switch 302.

Each switch 302, 304, 306 stores, for itself, one or more sustainability metrics 322, 324, 326. In some examples, a sustainability metric is dynamically determined by the switch, such as the current energy demand of the switch, traffic throughput of the switch, and so on. In some examples, a sustainability metric is configured in the switch by another device such as a fabric management server 352 or a host device. For example, the sustainability parameter is a sustainability rating that is programmed into the switch by the fabric management server 352 or a host device. A sustainability rating may be expressed as a value on a scale indicating a relative measure of how green the switch is (e.g., where lower values indicate less environmental and ecological impact). In some examples, switches 302, 304, 306 may report their sustainability metrics 322, 324, 326 to each other or to a fabric management server 352 through routing protocols. In a particular example, a fabric management server 352 issues a command to the switches to report their respective sustainability metrics 322, 324, 326.

Each switch 302, 304, 306 also includes a routing table 330. The routing table 330 includes, among other elements, an IP address and/or port of a next hop for each route to each destination endpoint address in the fabric 308. For example, the routing table 330 of switch 302 would identify the port addresses of switch 304 and switch 306 as next hops for different routes to the IP address of endpoint 342. In some examples, the routing table 330 indicates a cost metric for each path such as distance or congestion. In some examples, the routing table 330 indicates a sustainability metric of the next device in the route. For example, the routing table 330 of switch 302 would identify the sustainability metrics of switch 304 and switch 306. The switches in the fabric 308 update their routing tables dynamically by receiving state information about the fabric 308 from other switches or from a fabric management server 352. For example, the state information can indicate network congestion or failure. In some examples, the state information indicates the sustainability metric of each switch in the fabric.

Each switch 302, 304, 306 also includes a sustainability module 340 that routes packets based on a sustainability policy. The sustainability module selects a path to route the packet 318 to a next device (i.e., the next hop) based on one or more sustainability metrics for the available paths that will advance the packet 318 toward the destination endpoint 342. In some examples, a sustainability metric includes the energy demand of the next device. In some examples, a sustainability metric estimates a power demand of the link based on the speed of the link to the next device. In some implementations, the sustainability metric is a binary value, indicating either that the path is green or not green, or a sustainability rating that indicates a relative measure of the greenness of the path.

Consider an illustrative example in which the sustainability metric is based on a single sustainability parameter of the switch (e.g., an energy demand of the switch). In this example, a lower energy demand indicates a greener path. Continuing the example, where the sustainability metric of the path 310 to switch 304 is ‘3’ and the sustainability metric of the path 312 to switch 306 is ‘7’, the sustainability module 340 will select path 310 for routing the packet 318 to switch 304. That is, path 310 is the greener path. Consider another example in which switch 304 is ‘greener’ than switch ‘306’ based on the energy demand of the switches; however, in this example, consider that path 312 to switch 306 includes a link 364 that operates at a lower link speed (thus demanding less power) than any of the links 360, 362 in paths 310 to switch 304. In such an example, a routing decision may be based on the link speed as well as the energy demand of the switch, in which case the sustainability module 340 may select path 312 for routing the packet 318 to switch 306. That is, path 312 is the greener path. It will be appreciated that calculation of the sustainability metric may be based on a single factor or on a variety of weighted factors, including any of the factors discussed above, or based on other/additional factors not specifically disclosed and that may occur to one of skill in the art.

The packet 318 or frame containing the packet 318 includes a header, which is described in more detail below. In some implementations, the header specifies a sustainability policy. The sustainability module 340 uses the sustainability policy indicated by the header in determining how to route the packet 318. For example, the value encoded in a field of the header can indicate if a sustainability policy should be used and/or which sustainability policy. In some examples, the value encoded for the sustainability policy is a binary value. For example, the header may indicate a ‘1’ where sustainable routing should be employed and a ‘0’ otherwise. In other examples, there may be more than one sustainability policy and the value encoded for the sustainability policy indicates which sustainability policy to use. For example, one sustainability policy may indicate that the greenest possible path should be used, while another sustainability policy may indicate to use the greenest possible path while meeting a link speed requirement. It will be appreciated that other types of sustainability policies may be utilized. In some examples, the sustainability policy or policies may be stored on the fabric management server or another device (e.g., in a database) accessible to switch. In other examples, the sustainability policy may be configured in a look-up table or other data structure stored on the switch.

In some examples, the header also includes an energy demand counter value. The energy demand counter value is incremented with the energy demand associated with each path traversed in route to the destination endpoint. This energy demand associated with the path can be the energy demand of the switch or the energy demand of the physical link in combination with the energy demand of the switch. For example, prior to routing the packet 318 to switch 304 over path 310, switch 302 increments the energy demand counter value in the header of the packet with the current energy demand of switch 302 and the energy demand of the link to switch 304. The energy demand counter value accumulates the sustainability metric of each path traversed in route to the destination endpoint 342. That is, the energy demand counter will be incremented by switch 304 with its current energy demand and the energy demand of the link to the endpoint 342. Once the packet 318 reaches the destination endpoint 342, the value of the energy demand counter value can be recorded in a database. In some examples, the value of the energy demand counter value is used to calculate a cost savings of utilizing the sustainability policy. For example, the cost savings may be an expression of a reduction in energy demand, a reduction in digital emissions, a monetary value, and the like. The value of the energy demand counter value and/or the cost savings may be used as feedback the fabric management server 352 or a data center management server to further optimize packet routing the fabric (e.g., by reducing energy demand or other costs). The value of the energy demand counter value and/or the cost savings may also be reported to management server or administrative personnel for determining the effectiveness of the sustainability policy and/or whether sustainability goals are being met.

It will be appreciated that, although the sustainability module 340 is described in the context of a switch, the sustainability module 340 may be employed in other devices in the fabric, such as other network appliances, servers, endpoints, and so on.

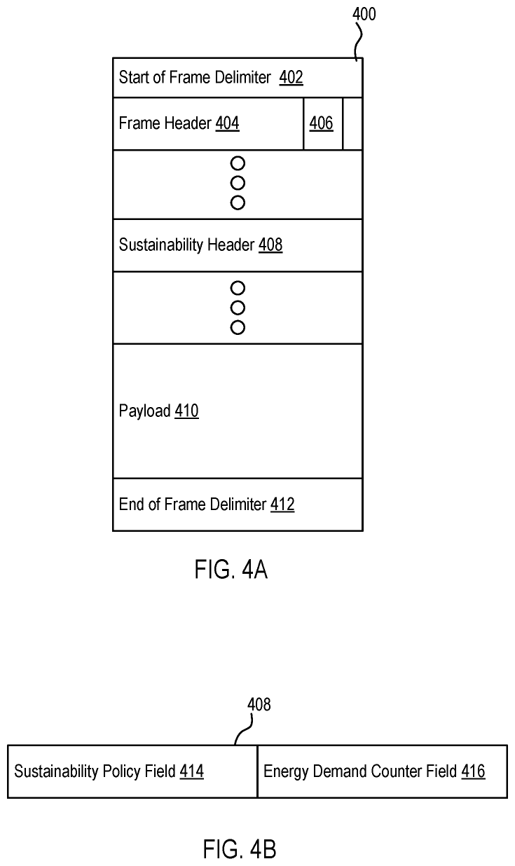

In some examples, the packet 318 is included in a frame and that frame is routed from the source endpoint through the switched fabric (e.g., switched fabric 112) to the destination endpoint. The frame includes information used in the routing, and in accordance with the present disclosure, includes information relating to sustainability-based routing. For further explanation, a frame used in accordance with aspects of the present disclosure is described with reference to FIGS. 4A-4B. FIG. 4A depicts example fields of a frame used in accordance aspects of the present disclosure; FIG. 4B depicts one example of a sustainability header of the frame of FIG. 4A.

Referring to FIG. 4A, in one example, an example frame 400 includes information used in sending a packet, in the form of payload, from a source to a destination. In one example, frame 400 includes a start-of-frame delimiter 402 that is used to indicate the start of a frame. A frame header 404 includes one or more fields used to specify certain controls and/or the presence of optional headers used in routing the frame. As an example, the frame header includes a sustainability header indicator 406. In one example, sustainability header indicator 406 is a bit that when set to one value (e.g., 0), indicates no sustainability header, and when set to another value (e.g., ‘1’), indicates a sustainability header. The frame 400 also includes a sustainability header 408, described in more detail below. The frame 400 may also include one or more extended headers and control information not depicted here. The frame includes a payload 410 which includes the packet data. The frame 400 also includes an end-of-frame delimiter 412 that is used to specify the end of the frame.

Based on tolling sustainability indicator 406 specifying that a sustainability header 408 is included in the frame 400, the sustainability header 408 is used in for routing the packet in accordance with a sustainability policy. In one example, referring to FIG. 4B, a sustainability header 408 includes one or more fields. In some implementations, the sustainability header 408 includes a sustainability policy field 414 that indicates a sustainability policy to be used in routing the packet, or that indicates the absence of a sustainability policy. Example sustainability policies are described above. In some implementations, the sustainability header 408 also includes a energy demand counter field 416. In one example, the energy demand counter field 416 accumulates the sustainability metrics for the paths that are traversed for a particular route from a source endpoint to a destination endpoint. Although examples of a frame and a sustainability header are described, other configurations and/or types of frames and/or sustainability headers may be used. A frame may include additional, fewer and/or other fields. Similarly, a tolling header (or other headers of the frame) may include additional, fewer and/or other fields.

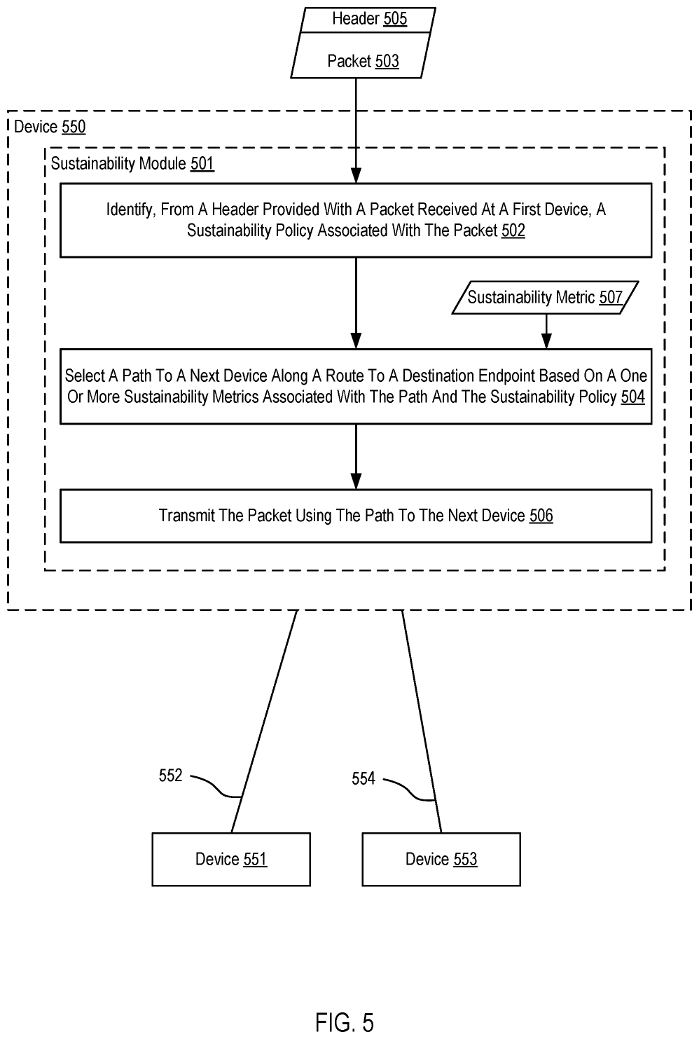

For further explanation, FIG. 5 sets forth a flow chart of an example method for greenest path routing in a switched communications fabric in accordance with at least one embodiment of the present disclosure. The example of FIG. 5 includes device 550 having a sustainability module 501 such as the sustainability module 340 of FIG. 3. In the example, of FIG. 5, the device is coupled to other devices 551, 553 through respective paths 552, 554. In some examples, the devices 550, 551, 553 are components of a switched communications fabric (not shown). In some examples, the switch communications fabric is a Fibre Channel fabric. In some examples, one or more of the devices 550, 551, 553 are network switches such as Fibre Channel switches.

The method of FIG. 5 includes identifying 502, from a header 505 provided with a packet 503 received at a first device 550, a sustainability policy associated with the packet 503. In some examples, a packet 503 of data is received the first device 550 with a header 505 such as sustainability header 408. For example, the packet 503 and header 505 may be provided in the same frame (e.g., a Fibre Channel frame). In another example, the header 505 may be part of the packet 503. The header 505 includes a field relating to a sustainability policy. In some implementations, the field indicates whether the packet 503 should be routed based on sustainability information relating to devices in the fabric. In such implementations, the value may be a binary value indicating that sustainability information should or should not be relied upon in routing the packet 503. In some implementations, a value in the field indicates a specific sustainability policy to use for routing the packet 503. For example, there may be multiple sustainability policies that can be used. As described above, a packet that is routed in adherence to a sustainability policy utilizes sustainability metrics of the devices in fabric when making routing decisions. In some examples, the sustainability module 501 identifies 502 the sustainability policy associated with the packet 503 by reading the header 505 and determining whether the packet should be routed using sustainability information. Where the header 505 identifies a specific sustainability policy, the sustainability module 501 can identify the specific sustainability policy based on a value in the header that corresponds to a sustainability policy entry in a data structure, which may be remote or stored on the device 550.

The method of FIG. 5 also includes selecting 504 a path 552 to a next device 551 along a route to a destination endpoint based on one or more sustainability metrics 507 associated with the path 552 and the sustainability policy. As described above, the sustainability metric 507 can be indicative of the environmental and ecological impact associated with using a path for routing the packet 503; or, in other words, the sustainability metric can indicate whether one path is ‘greener’ than another path. In some implementations, a sustainability metric 507 associated with a path to a device is based on the energy demand of the device. In some implementations, a sustainability metric 507 associated with a path to a device is based on the energy demand of the link between the first device 550 and the next device 550, 551, 553. For example, the energy demand of the link can be derived from the link speed connecting the devices. In some implementations, a sustainability metric is a sustainability rating, which may be a relative measure of how green a particular path is. In some examples, the sustainability metrics 507 are stored in the routing table of each device 550, 551, 553. In some examples, the sustainability metrics 507 of other device in the fabric are received from those devices using routing protocols, or are received from a fabric management server. A device can then update its routing table with the sustainability metrics. In some examples, the sustainability metrics in the routing tables are updated each time a fabric notification occurs.

In some implementations, the sustainability module 501 selects 504 a path 552 to a next device 551 along a route to a destination endpoint based on one or more sustainability metrics 507 associated with the path 552 and the sustainability policy by identifying all of the candidate paths 552, 554 for routing the packet 503 to a candidate next device 551, 553. The sustainability module 501 compares the sustainability metric(s) associated with each candidate path 552, 554. The sustainability module 501 then selects a path 552 based on the path 552 being associated with the lowest sustainability metric value(s) while still satisfying the sustainability policy, other routing policies, service level requirements, and so on. In other words, the sustainability module 501 selects the greenest path among the available paths that satisfy service level requirements.

The method of FIG. 5 also includes transmitting 506 the packet 503 using the path 552 to the next device 551. In some examples, the sustainability module 501 transmits 506 the packet 503 to the next device 551 by routing the packet 503 using address, port, and/or interface information for the path stored in the routing table to send the packet.

Although FIG. 5 is described in the context of a sustainability module 501 on a switch or other routing device in the fabric, in some example a server or host device includes the sustainability module 501. In such examples, the server or host device selects each path to a next device to generate an end-to-end route based on the one or more sustainability metrics. The end-to-end route is provided with the packet to the switched communications fabric. Devices in the fabric then route the packet in accordance each path specified in the end-to-end route.

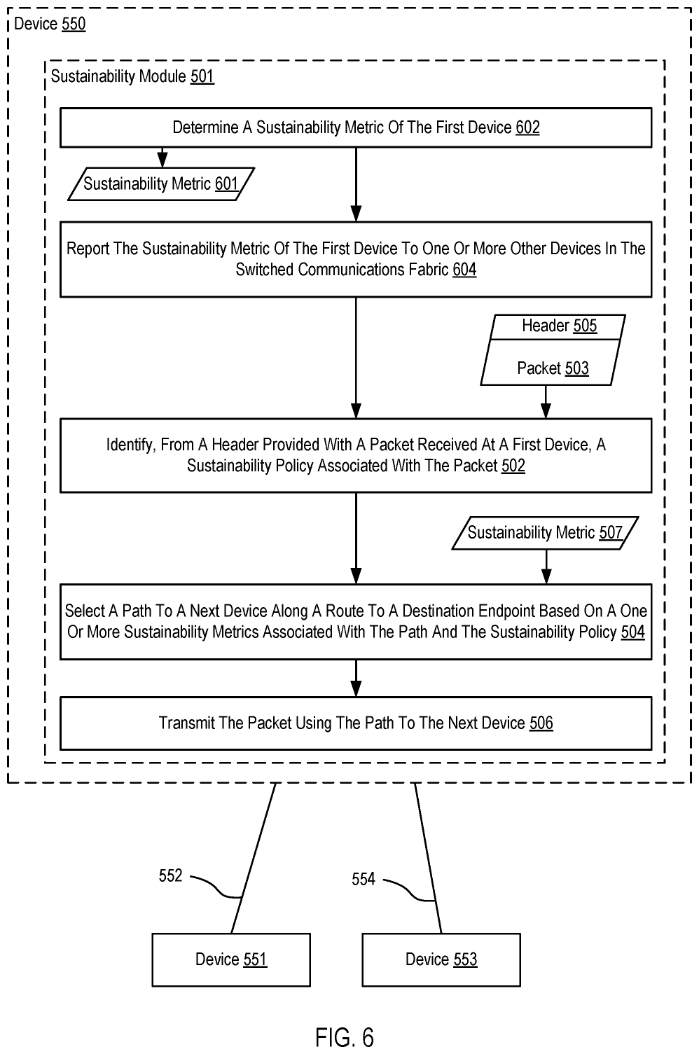

For further explanation, FIG. 6 sets forth a flow chart of another example method for greenest path routing in a switched communications fabric in accordance with at least one embodiment of the present disclosure. The method of FIG. 6 extends the method of FIG. 5 in that the method of FIG. 6 also includes identifying 602 a sustainability metric 601 of the first device 550. In some implementations, the sustainability module 501 identifies 602 a sustainability metric 601 by determining a current energy demand of the device 550 using power management circuitry.

The method of FIG. 6 also includes reporting 604 the sustainability metric 601 of the first device 550 to one or more other devices 551, 553 in the switched communications fabric. In some implementations, the sustainability module 501 reports 604 the sustainability metric 601 of the first device 550 by transmitting the sustainability metric 601 to other devices 551, 553, such as other switches, servers, endpoints) in the switch fabric using routing protocols and/or fabric notifications. In some implementations, the sustainability module 501 reports 604 the sustainability metric 601 of the first device 550 by updating a fabric management server with the sustainability metric 601, or by receiving a command from a host to report its current energy demand.

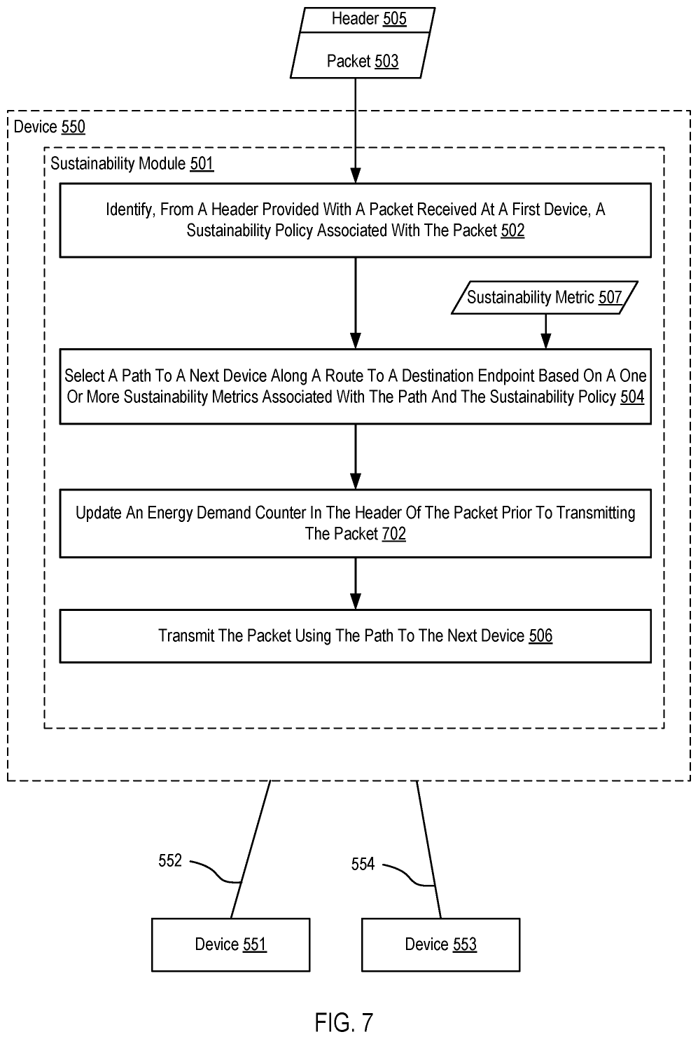

For further explanation, FIG. 7 sets forth a flow chart of another example method for greenest path routing in a switched communications fabric in accordance with at least one embodiment of the present disclosure. The method of FIG. 7 extends the method of FIG. 5 in that the method of FIG. 7 also includes updating 702 an energy demand counter in the header 505 of the packet 503 prior to transmitting the packet 503. The energy demand counter accumulates that energy demand of each hop in the route between endpoints. In some examples, the energy demand counter is updated based on the sustainability metrics. In some implementations, the sustainability module 501 updates 702 the energy demand counter in the header 505 of the packet 503 by incrementing the value of the energy demand counter with the current energy demand of the first device 550. In some examples, the energy demand counter is updated based on the sustainability metrics. In some implementations, the sustainability module 501 updates 702 the energy demand counter in the header 505 of the packet 503 by incrementing the value of the energy demand counter with the current energy demand of the first device 550 and the energy demand of the link to the next device 551 (e.g., based on the speed of the link).

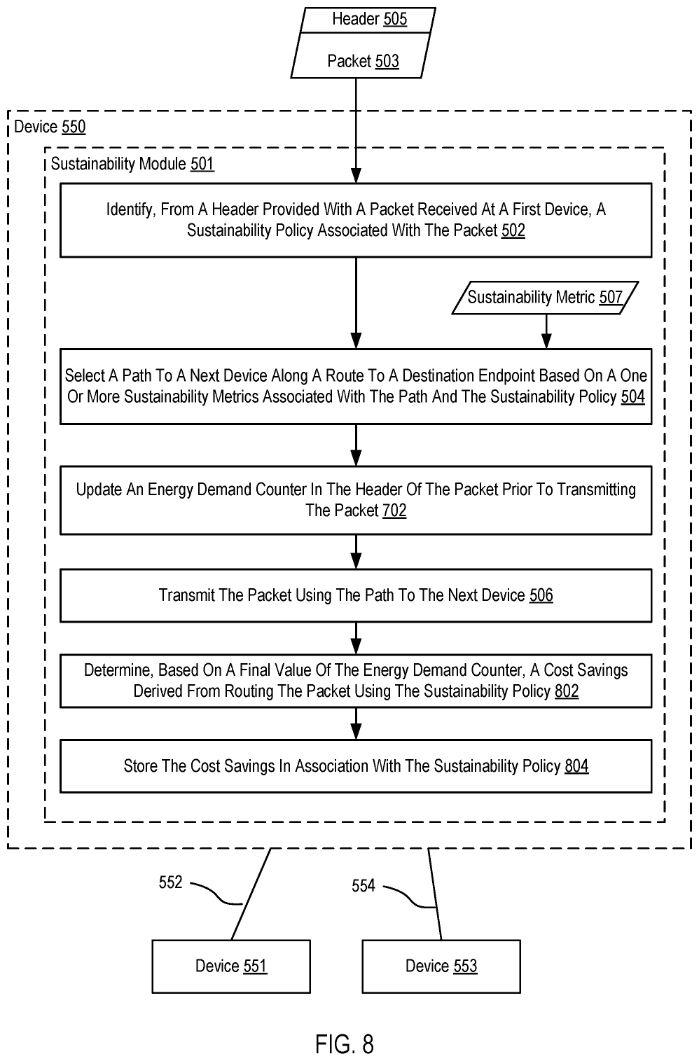

For further explanation, FIG. 8 sets forth a flow chart of another example method for greenest path routing in a switched communications fabric in accordance with at least one embodiment of the present disclosure. The method of FIG. 8 extends the method of FIG. 7 in that the method of FIG. 8 also includes determining 802, based on a final value of the energy demand counter, a cost savings derived from routing the packet using the sustainability policy. In some implementations, the endpoint receives the packet 503 and reads the value of the energy demand counter from the packet. In these implementations, the endpoint can report the value of the energy demand value to a fabric management server, host, or other device, or the endpoint can determine the cost savings itself. To determine the cost savings, the accumulated energy demand represented by the energy demand counter is compared to an average energy demand of a route that does not use a sustainability policy or sustainability metrics for routing decisions. The difference between the energy demands represents the cost savings, which can be expressed as a monetary cost savings based on utility rates.

In some implementations, the last device in the route prior to reaching the endpoint detects that the next hop is the endpoint. In these implementations, the device reports the value of the energy demand counter to a fabric management server, host, or other device, which calculates the cost savings as discussed above. The last device prior to the endpoint can also indicate whether a sustainability policy and/or which sustainability policy was used to route the packet.

The method of FIG. 8 also includes storing 804 the cost savings in association with the sustainability policy. In various examples, the cost savings is stored in a database entry by the endpoint, fabric management server, host, or other device. The entry can also indicate whether a sustainability policy was used or which sustainability was used to route the packet. In some examples, the entry also includes the end-to-end path traversed by the packet.

In view of the foregoing, it can be seen that embodiments of the present disclosure provide a sustainability management module and sustainability header that improve the energy efficiency and performance of a network communications infrastructure. Embodiments advantageously provide a sustainability header that enables the setting of a sustainability policy used for routing the packet within the infrastructure. The a ‘green’ policy for packet routing can be indicated. Network devices select a path between endpoints based sustainability metrics associated with the path. For example, the path is selected based on an energy demand of the infrastructure devices and the links between them. As the packet traverses the path, the header can be updated with the energy demand of each hop such that the energy demand of the ‘green’ path can be compared to the energy demand based on a standard routing policy. This improves the infrastructure by allowing the customer and the operator of the infrastructure to determine whether sustainability targets are being met. Further, the information is fed back into the system to improve the energy efficiency and performance of devices within the infrastructure. For example, where ‘green’ paths that meet service level requirements can be identified, the system may use that information to set routing tables to reduce the overall energy demand of the infrastructure, even if the customer does not set the sustainability policy.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
identifying, from a header provided with a packet received at a first device, a sustainability policy associated with the packet;
selecting a path to a next device along a route to a destination endpoint based on a one or more sustainability metrics associated with the path and the sustainability policy; and
transmitting the packet using the path to the next device.

2. The method of claim 1, wherein the sustainability policy indicates a policy for routing the packet based on a utilization of sustainability metrics.

3. The method of claim 1, wherein the one or more sustainability metrics includes a device energy demand metric of the next device.

4. The method of claim 3, wherein the one or more sustainability metrics includes a link energy demand metric based on link speed between the first device and the next device.

5. The method of claim 1, wherein the first device and the next device are switches among a plurality of switches included in a switched communications fabric.

6. The method of claim 5, wherein one or more sustainability metrics are included in a routing table stored on the first device.

7. The method of claim 5 further comprising:
determining a sustainability metric of the first device; and
reporting the sustainability metric of the first device to one or more other devices in the switched communications fabric.

8. The method of claim 1 further comprising:
updating an energy demand counter in the header of the packet prior to transmitting the packet.

9. The method of claim 8 further comprising:
determining, based on a final value of the energy demand counter, a cost savings derived from routing the packet using the sustainability policy; and
storing the cost savings in association with the sustainability policy.

10. The method of claim 1, wherein the first device and the next device are among a plurality of devices in a Fibre Channel fabric; and wherein the packet is routed through the Fibre Channel fabric.

11. A device comprising:
a processing device; and
memory operatively coupled to the processing device, wherein the memory stores computer program instructions that, when executed, cause the processing device to:
identify, from a header provided with a packet received at the device, a sustainability policy associated with the packet;
select a path to a next device along a route to a destination endpoint based on a one or more sustainability metrics associated with the path and the sustainability policy; and
transmit the packet using the path to the next device.

12. The device of claim 11, wherein the computer program instructions, when executed, cause the processing device to:
determine a sustainability metric of the device; and
report the sustainability metric of the device to one or more other devices in a switched communications fabric.

13. The device of claim 11, wherein the computer program instructions, when executed, cause the processing device to:
update an energy demand counter in the header of the packet prior to transmitting the packet.

14. The device of claim 13, wherein the computer program instructions, when executed, cause the processing device to:
determine, based on a final value of the energy demand counter, a cost savings derived from routing the packet using the sustainability policy; and
store the cost savings in association with the sustainability policy.

15. The device of claim 11, wherein the device is configured for communication via a Fibre Channel protocol.

16. A computer program product comprising a computer readable storage medium, wherein the computer readable storage medium comprises computer program instructions that, when executed:
identify, from a header provided with a packet received at a first device, a sustainability policy associated with the packet;
select a path to a next device along a route to a destination endpoint based on a one or more sustainability metrics associated with the path and the sustainability policy; and
transmit the packet using the path to the next device.

17. The computer program product of claim 16, wherein the computer readable storage medium comprises computer program instructions that, when executed:
determine a sustainability metric of the first device; and
report the sustainability metric of the first device to one or more other devices in a switched communications fabric.

18. The computer program product of claim 16, wherein the computer readable storage medium comprises computer program instructions that, when executed:
update an energy demand counter in the header of the packet prior to transmitting the packet.

19. The computer program product of claim 18, wherein the computer readable storage medium comprises computer program instructions that, when executed:
determine, based on a final value of the energy demand counter, a cost savings derived from routing the packet using the sustainability policy; and
store the cost savings in association with the sustainability policy.

20. The computer program product of claim 16, wherein the one or more sustainability metrics includes a device energy demand metric of the next device read from a routing table.
